(19) United States
(12) Patent Application Publication
(10) Pub. No.: US 2018/0004001 A1
(43) Pub. Date: Jan. 4, 2018

(54) STRUCTURE AND PRISM THAT PERFORATES OUT OF THE STRUCTURE

(71) Applicant: Barbara Ann Kent, Mamaroneck, NY (US)

(72) Inventor: Barbara Ann Kent, Mamaroneck, NY (US)

(21) Appl. No.: 15/640,682

(22) Filed: Jul. 3, 2017

Related U.S. Application Data
(60) Provisional application No. 62/357,672, filed on Jul. 1, 2016.

(51) Int. Cl. G02B 27/22; G09F 1/06; B65D 5/54; G09F 19/12; B65D 5/42

(52) U.S. Cl. CPC G02B 27/2292; G09F 19/12; B65D 5/4266; B65D 5/54; G09F 1/06

(57) ABSTRACT

Embodiments of the present invention may provide a card style carrier that incorporates a prism that perforates out of a structure, such as a carrier card or a box. This may provide the capability by which electronically displayed content may be linked to physical products, while at the same time providing enhancement of the display. In an embodiment, a card may comprise a thin flat sheet of optically transparent material having a perforated portion, the perforated portion having an approximately pentagonal shape, but including four sides of the pentagon, the four sides divided by foldable creases, wherein the perforated portion is adapted to be removed from the thin flat sheet, folded along the foldable creases, and assembled to form a pyramidal prism.

### BACKGROUND

The present invention relates to a card style carrier that incorporates a prism that perforates out of a structure, such as a carrier card or a box.

Advertisers or vendors commonly use electronic display devices, such as handheld or other devices, to display advertising or product content. In addition, it may be desirable to link such electronically displayed content to physical products, along with physical advertising or product content. However, electronic display devices may not be ideal for all types of content. Some enhancement of the display may be desired. Accordingly, a need arises for a technique by which electronically displayed content may be linked to physical products, while at the same time providing enhancement of the display.

### SUMMARY

Embodiments of the present invention may provide a card style carrier that incorporates a prism that perforates out of a structure, such as a carrier card or a box. This may provide the capability by which electronically displayed content may be linked to physical products, while at the same time providing enhancement of the display.

In an embodiment, a card may comprise a thin flat sheet of optically transparent material having a perforated portion, the perforated portion having an approximately pentagonal shape, but including four sides of the pentagon, the four sides divided by foldable creases, wherein the perforated portion is adapted to be removed from the thin flat sheet, folded along the foldable creases, and assembled to form a pyramidal prism.

In embodiments, a first end of the perforated portion may comprise at least one tab, a second end of the perforated portion comprises at least one slot corresponding to the at least one tab, and the perforated portion is adapted to be assembled to form a pyramidal prism by inserting the at least one tab into the corresponding at least one slot. The thin flat sheet may have a shape selected from a group of shapes comprising square, rectangular, circular, oval, and irregular. The card may further comprise a device adapted to attach the card to a neck of a bottle. The device may be adapted to attach the card to the neck of the bottle comprises a flat sheet having a hole. The device may be adapted to attach the card to the neck of the bottle comprises a hook formed from a flat sheet. The pyramidal prism may be adapted to be placed on a display screen and to project a holographic-like image of information displayed on the display screen.

In an embodiment, a pyramidal prism may be adapted to be assembled from a perforated portion of a thin flat sheet of optically transparent material, the perforated portion having an approximately pentagonal shape, but including four sides of the pentagon, the four sides divided by foldable creases, the perforated portion is adapted to be removed from the thin flat sheet, folded along the foldable creases, and assembled to form the pyramidal prism.

In embodiments, a first end of the perforated portion may comprise at least one tab, a second end of the perforated portion comprises at least one slot corresponding to the at least one tab, and the perforated portion is adapted to be assembled to form a pyramidal prism by inserting the at least one tab into the corresponding at least one slot. The thin flat sheet may have a shape selected from a group of shapes comprising square, rectangular, circular, oval, and irregular. The pyramidal prism may further comprise a device adapted to attach the card to a neck of a bottle. The may be device adapted to attach the card to the neck of the bottle comprises a flat sheet having a hole. The device may be adapted to attach the card to the neck of the bottle comprises a hook formed from a flat sheet. The pyramidal prism may be adapted to be placed on a display screen and to project a holographic-like image of information displayed on the display screen. The thin flat sheet may be adapted to be included in a box. The thin flat sheet may be adapted to be attached to a box.

In an embodiment, a box may comprise a thin flat sheet of optically transparent material having a perforated portion, the perforated portion having an approximately pentagonal shape, but including four sides of the pentagon, the four sides divided by foldable creases, wherein the perforated portion is adapted to be removed from the card, folded along the foldable creases, and assembled to form a pyramidal prism.

In embodiments, a first end of the perforated portion may comprise at least one tab, a second end of the perforated portion comprises at least one slot corresponding to the at least one tab, and the perforated portion is adapted to be assembled to form a pyramidal prism by inserting the at least one tab into the corresponding at least one slot. The flat sheet may have a shape selected from a group of shapes comprising square, rectangular, circular, oval, and irregular. The pyramidal prism may be adapted to be placed on a display screen and to project a holographic-like image of information displayed on the display screen.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of a card according to an embodiment of the present invention.

FIG. 2 is an exemplary diagram of an assembled prism according to an embodiment of the present invention.

FIG. 3 is an exemplary diagram of a card according to an embodiment of the present invention.

FIG. 4 is an exemplary diagram of a card according to an embodiment of the present invention.

FIG. 5 is an exemplary diagram of a assembled prism in use on a display device according to an embodiment of the present invention.

FIG. 6 is an exemplary diagram of a card according to an embodiment of the present invention.

FIG. 7 is an exemplary diagram of a card according to an embodiment of the present invention.

FIG. 8 is an exemplary diagram of a card according to an embodiment of the present invention.

FIG. 9 is an exemplary diagram of a card according to an embodiment of the present invention.

FIG. 10 is an exemplary diagram of a box according to an embodiment of the present invention.

### DETAILED DESCRIPTION

Embodiments of the present invention may provide a card style carrier that incorporates a perforated prism that perforates out of a structure, such as a carrier card or a box.

In an embodiment, the structure may include a card, such as a carrier card, or the structure may include a box, such as a box enclosing a liquor bottle or the like. The structure may be made of an optically transparent material, such as plastic, may be adapted to fit over, on, or around an object, such as a bottle, button, or handle, etc. The structure may include a perforated shape that may form a prism, which would punch or snap out of the structure. The shape may be assembled to form a prism that would transmit an image. For example, once the shape has been perforated out, it may then be folded and secured, using for example, tabs into slots, tape, glue, or other fastening technique, to form a prism. The prism so formed may be used to with an electronic display device, such as a smartphone, tablet, or larger display device and may project a holographic-like image from an image, video, or app that is shown using the electronic display device.

In an embodiment, a card may be in multiple formats depending on usage requirements. For example, the card may have a flat square or rectangular format, which may be advantageous for handouts and in pack distribution. The card may have a flat circular or oval format, which may be advantageous for handouts and in pack distribution. The card may include or be attached to a necker, which may be advantageous for use on products or bottles. The card may include or be attached to a hook necker, which may be advantageous for use on products or bottles. The card may include or be attached or attachable to an article of clothing, such as a shirt, using a button, or for use on any type of clothing. It is to be noted that these descriptions of card shapes and attachments are merely examples. The present invention is not limited to any particular card shapes or attachments, but rather, contemplates use with any card shapes or attachment type.

In an embodiment, a box may be in multiple formats depending on usage requirements. For example, the box may have a tall or relatively low or flat format, depending on the object or product to be enclosed in the box. It is to be noted that these descriptions of box shapes are merely examples. The present invention is not limited to any particular box shapes or attachments, but rather, contemplates use with any box shapes or attachment type.

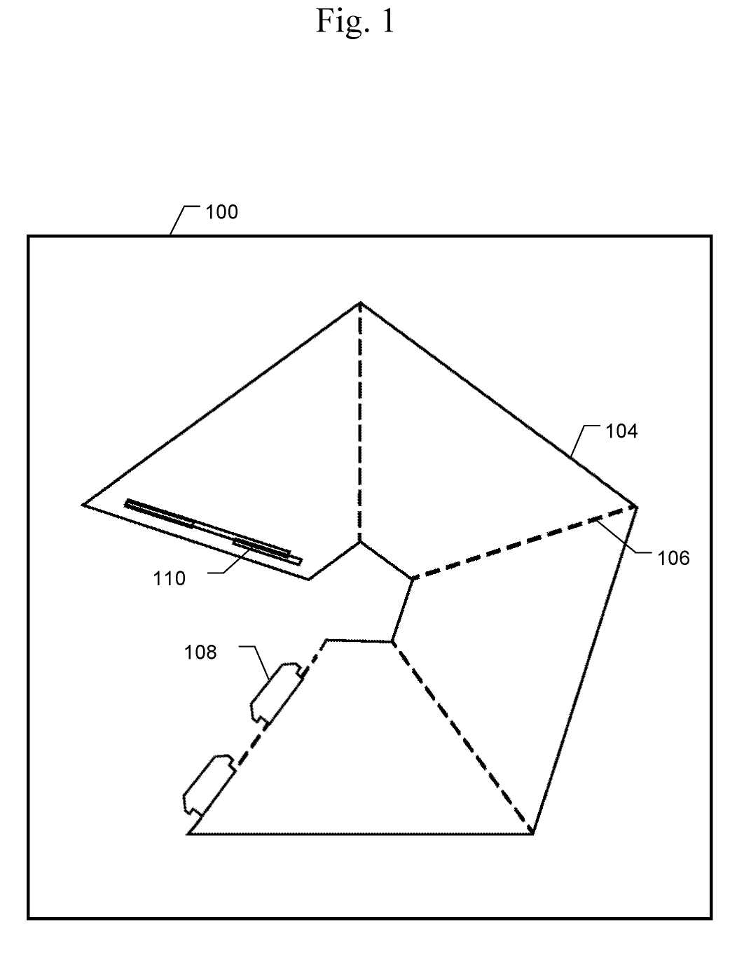

An exemplary embodiment of a card 100 according to the present invention is shown in FIG. 1. Card 100 may include a prism 102, defined by scored lines 104, and including creased score lines 106, one or more tabs 108, and one or more corresponding slots 110. In this example, card 100 is a square of approximately 4.75 by 4.75 inches, and the prism 102 is approximately 3.5 by 3.5 inches. It is to be noted that this is merely an example. The present invention is not limited to any particular size or shape, but rather, contemplates application to any size or shape. In this example, prism 102 may be scored 104 with perforated lines, such as kiss-cut, diecut, or otherwise perforated lines. To assemble the prism, a user may pop out the prism 102 from the background card 100 along the scored lines 104. Once popped out, the user may then fold along the creased scorelines 106, and inserts the tabs 108 into the slots 110 to complete assembly of the prism.

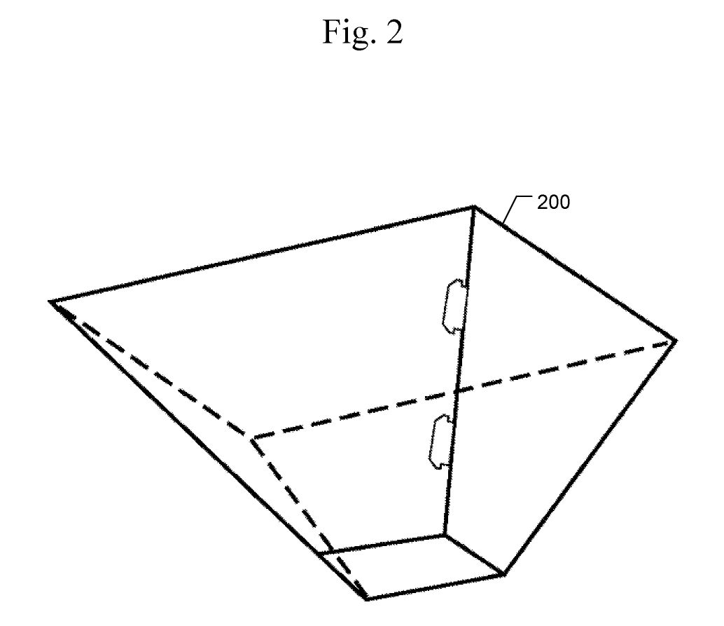

Card 100 may be made of an optically transparent material, such as a clear plastic material. The prism may be, for example, kiss-cut, diecut, or otherwise perforated into the card. The plastic material may be thin enough to fold into a prism along the creased score lines 106, and may have one or more tabs 108 that may be inserted into one or more slots 110 in order to hold the structure into the final formed prism shape. An example of an assembled prism 200 is shown in FIG. 2. Card 100 itself may be have no printing or may be printed in any color. Further, card 100 may also have an under printing of, for example, white.

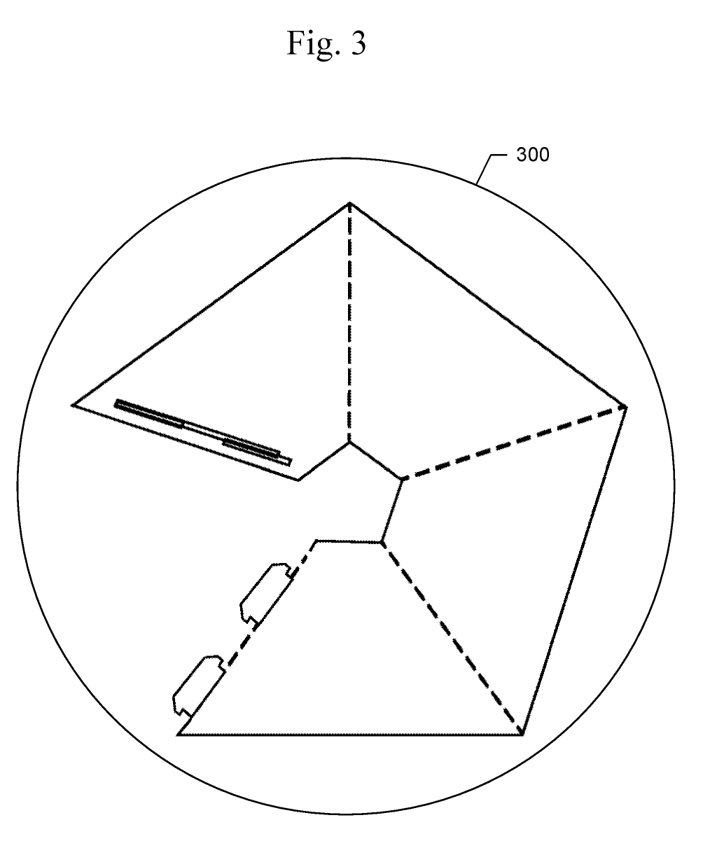

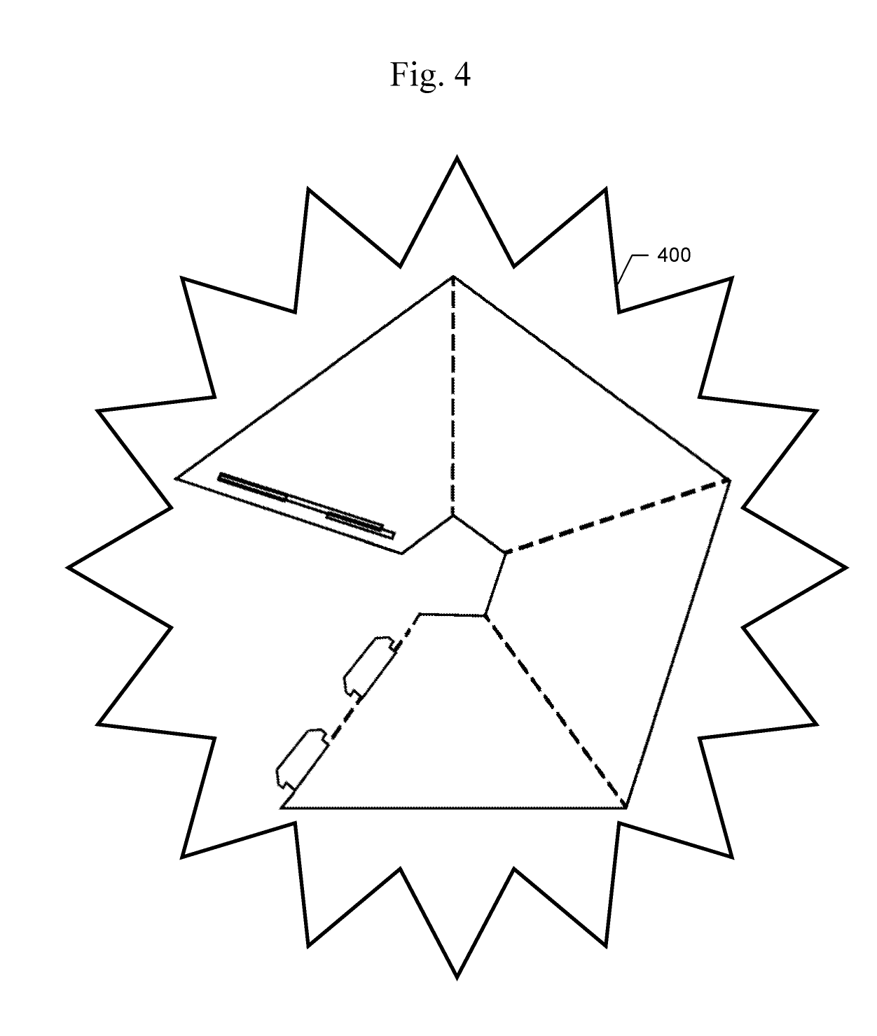

The present invention is not limited to any particular size or shape. For example, card 100, shown in FIG. 1, may be a rectangle of any size instead of a square. Likewise, as in the example shown in FIG. 3, a card 300, may be circular, or oval, and of any size. Further, as in the example shown in FIG. 4, a card 400, may be any regular or irregular shape or size. In all these cases, the prism itself may be assembled to form the structure shown in FIG. 2.

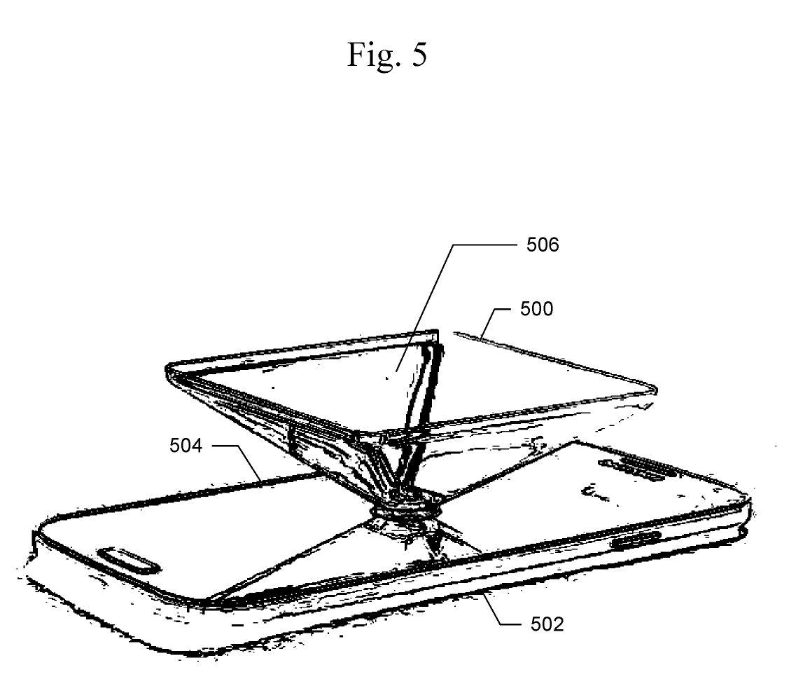

An example of an assembled prism 500 in use on a display device 502 is shown in FIG. 5. Prism 500 may be place onto a portion of the display 504 of display device 502. An image or video may be displayed on at least the portion of the display 504 covered by prism 500. A holographic-like representation of the image or video may then be displayed within the body of prism 500. Display device 502 may be any type of display device, such as a smartphone, tablet, computer display screen, television, etc. The displayed image or video may be displayed with any standard, publicly available, proprietary, custom, or other software or application.

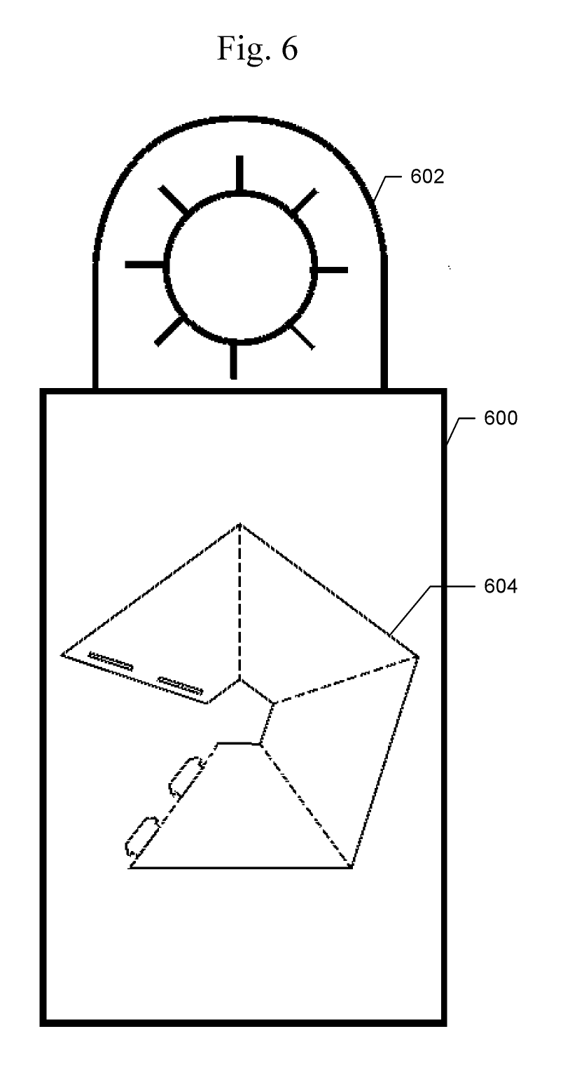

An exemplary embodiment of a card 600 according to the present invention is shown in FIG. 6. In this example, card 600 may be in the form of a hang tag that may include, or be attached to, a necker 602. Necker 602 is a device that provides the capability to hang a hang tag from, for example, the neck of a bottle. In this example, necker 802 is in the form of a tab having a hole. In this example, card 600 is a rectangle of approximately 4 by 6.5 inches, the prism 604 is approximately 3.5 by 3.5 inches, necker 602 is approximately 3 by 3 inches, and the overall size of the hang tag with necker is approximately 4 by 9.25 inches. It is to be noted that this is merely an example. The present invention is not limited to any particular size or shape, but rather, contemplates application to any size or shape.

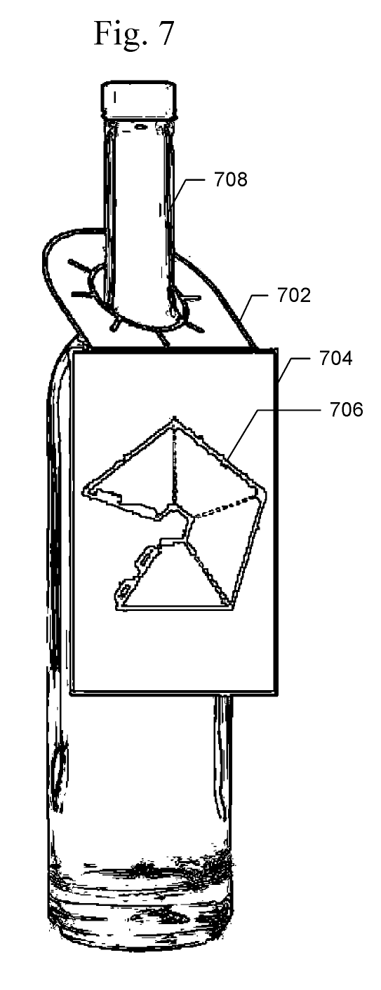

An example of the use of a necker 702 to hang a hang tag 704 including a prism 706 from the neck of a bottle 708 is shown in FIG. 7.

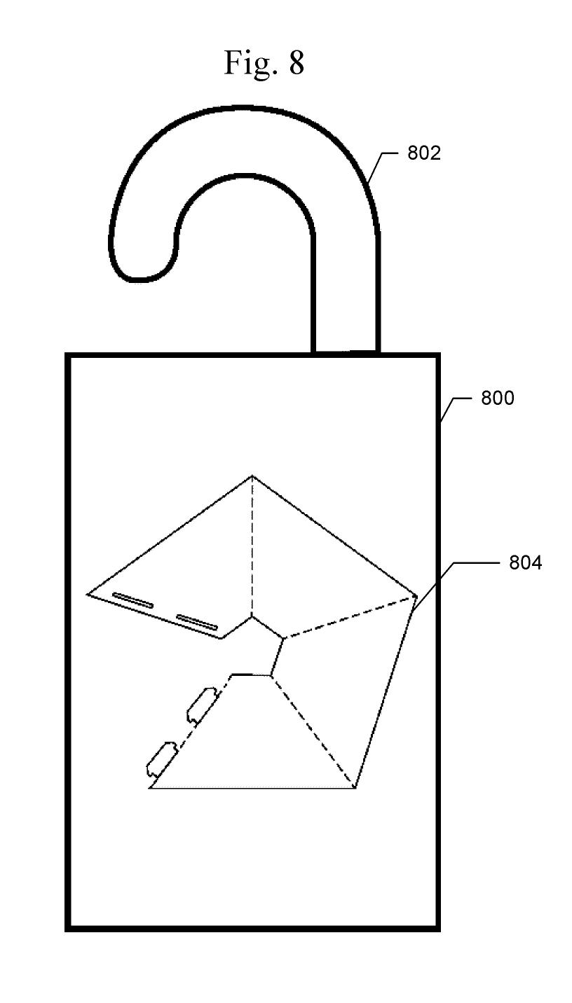

An exemplary embodiment of a card 800 according to the present invention is shown in FIG. 8. In this example, card 800 may be in the form of a hang tag that may include, or be attached to, a necker 802. Necker 802 is a device that provides the capability to hang a hang tag from, for example, the neck of a bottle. In this example, necker 802 is in the form of a hook. In this example, card 800 is a rectangle of approximately 4 by 6.5 inches, the prism 804 is approximately 3.5 by 3.5 inches, necker 802 is approximately 3 by 3 inches, and the overall size of the hang tag with necker is approximately 4 by 9.25 inches. It is to be noted that this is merely an example. The present invention is not limited to any particular size or shape, but rather, contemplates application to any size or shape.

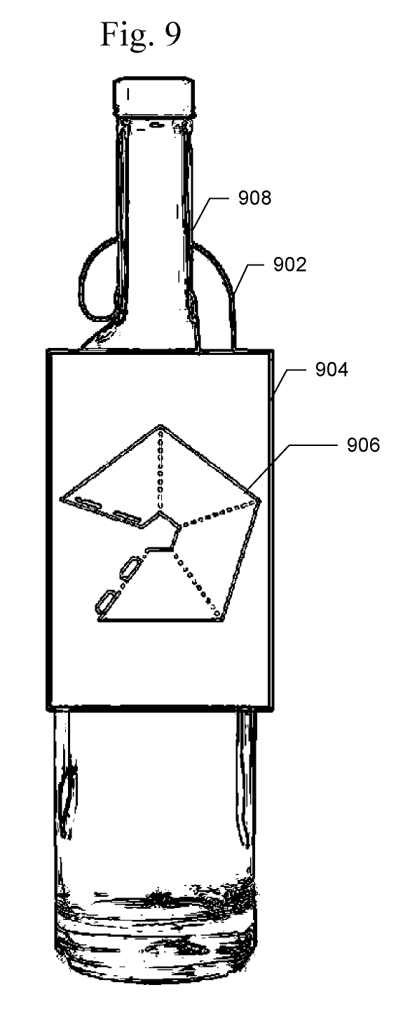

An example of the use of a necker 902 to hang a hang tag 904 including a prism 906 from the neck of a bottle 908 is shown in FIG. 9.

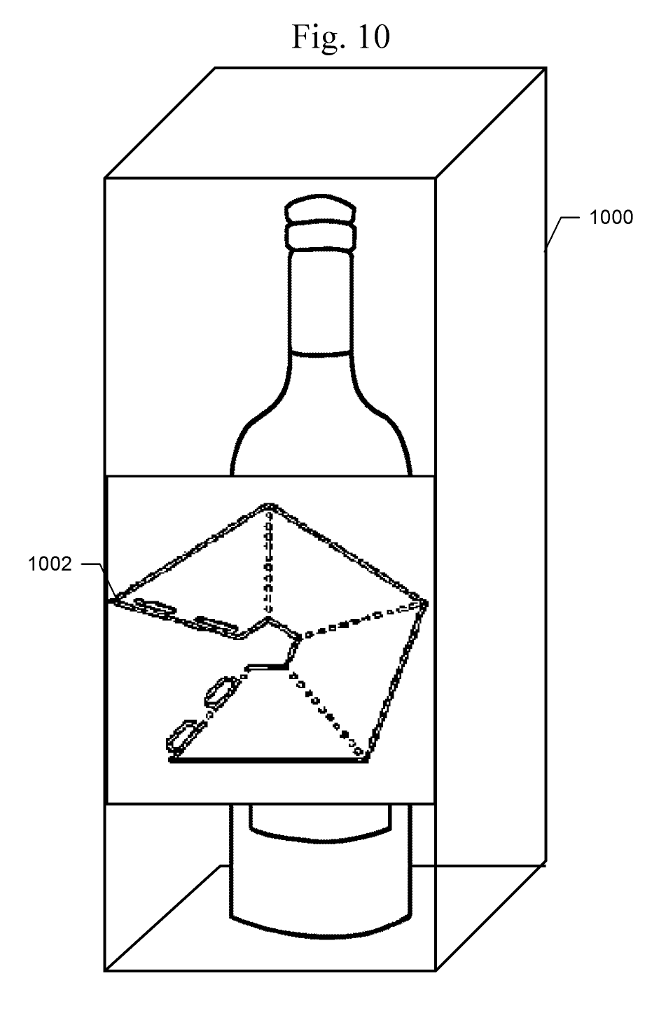

An exemplary embodiment of a box 1000 according to the present invention is shown in FIG. 10. In this example, prism 1002 may be included in or attached to a side or face of box 1000. Box 1000 may be of any size appropriate to enclose the object or product contained therein, and prism 1002 may be sized accordingly. For example, prism 1002 may be approximately 3.5 by 3.5 inches, while box 1000 may be sized to enclose a bottle, such as a wine or liquor bottle. It is to be noted that this is merely an example. The present invention is not limited to any particular size or shape, but rather, contemplates application to any size or shape. In this example, prism 1002 may be scored with perforated lines, such as kiss-cut, diecut, or otherwise perforated lines. To assemble the prism, a user may pop out the prism 1002 from box 1000 along the scored lines. Once popped out, the user may then assemble prism 1002 as described above.

Box 1000 may be made of an optically transparent material, such as a clear plastic material. The prism may be, for example, kiss-cut, diecut, or otherwise perforated into the card. The plastic material may be thin enough to fold into a prism along the creased score lines, and may have one or more tabs that may be inserted into one or more slots in order to hold the structure into the final formed prism shape.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A card, comprising:
a thin flat sheet of optically transparent material having a perforated portion, the perforated portion having an approximately pentagonal shape, but including four sides of the pentagon, the four sides divided by foldable creases;
wherein the perforated portion is adapted to be removed from the thin flat sheet, folded along the foldable creases, and assembled to form a pyramidal prism.

2. The card of claim 1, wherein a first end of the perforated portion comprises at least one tab, a second end of the perforated portion comprises at least one slot corresponding to the at least one tab, and the perforated portion is adapted to be assembled to form a pyramidal prism by inserting the at least one tab into the corresponding at least one slot.

3. The card of claim 1, wherein the thin flat sheet has a shape selected from a group of shapes comprising square, rectangular, circular, oval, and irregular.

4. The card of claim 3, further comprising a device adapted to attach the card to a neck of a bottle.

5. The card of claim 4, wherein the device adapted to attach the card to the neck of the bottle comprises a flat sheet having a hole.

6. The card of claim 4, wherein the device adapted to attach the card to the neck of the bottle comprises a hook formed from a flat sheet.

7. The card of claim 1, wherein the pyramidal prism is adapted to be placed on a display screen and to project a holographic-like image of information displayed on the display screen.

8. A pyramidal prism adapted to be assembled from a perforated portion of a thin flat sheet of optically transparent material, the perforated portion having an approximately pentagonal shape, but including four sides of the pentagon, the four sides divided by foldable creases, the perforated portion is adapted to be removed from the thin flat sheet, folded along the foldable creases, and assembled to form the pyramidal prism.

9. The pyramidal prism of claim 8, wherein a first end of the perforated portion comprises at least one tab, a second end of the perforated portion comprises at least one slot corresponding to the at least one tab, and the perforated portion is adapted to be assembled to form a pyramidal prism by inserting the at least one tab into the corresponding at least one slot.

10. The pyramidal prism of claim 8, wherein the thin flat sheet has a shape selected from a group of shapes comprising square, rectangular, circular, oval, and irregular.

11. The pyramidal prism of claim 10, further comprising a device adapted to attach the card to a neck of a bottle.

12. The pyramidal prism of claim 11, wherein the device adapted to attach the card to the neck of the bottle comprises a flat sheet having a hole.

13. The pyramidal prism of claim 11, wherein the device adapted to attach the card to the neck of the bottle comprises a hook formed from a flat sheet.

14. The pyramidal prism of claim 8, wherein the pyramidal prism is adapted to be placed on a display screen and to project a holographic-like image of information displayed on the display screen.

15. The pyramidal prism of claim 8, wherein the thin flat sheet is adapted to be included in a box.

16. The pyramidal prism of claim 8, wherein the thin flat sheet is adapted to be attached to a box.

17. A box, comprising:
a thin flat sheet of optically transparent material having a perforated portion, the perforated portion having an approximately pentagonal shape, but including four sides of the pentagon, the four sides divided by foldable creases;
wherein the perforated portion is adapted to be removed from the card, folded along the foldable creases, and assembled to form a pyramidal prism.

18. The box of claim 17, wherein a first end of the perforated portion comprises at least one tab, a second end of the perforated portion comprises at least one slot corresponding to the at least one tab, and the perforated portion is adapted to be assembled to form a pyramidal prism by inserting the at least one tab into the corresponding at least one slot.

19. The box of claim 17, wherein the flat sheet has a shape selected from a group of shapes comprising square, rectangular, circular, oval, and irregular.

20. The box of claim 17, wherein the pyramidal prism is adapted to be placed on a display screen and to project a holographic-like image of information displayed on the display screen.
